(19) United States
(12) Patent Application Publication
(10) Pub. No.: US 2012/0199999 A1
(43) Pub. Date: Aug. 9, 2012

(54) PROCESS FOR PRODUCING LIQUID CRYSTAL POLYESTER-IMPREGNATED BASE MATERIAL

(75) Inventors: Changbo SHIM, Tsukuba-shi (JP); Sadanobu IWASE, Tsukuba-shi (JP)

(73) Assignee: SUMITOMO CHEMICAL COMPANY, LIMITED, Tokyo (JP)

(21) Appl. No.: 13/362,575

(22) Filed: Jan. 31, 2012

(30) Foreign Application Priority Data
Feb. 8, 2011 (JP) 2011-024840

(51) Int. Cl. B29D 7/01

(52) U.S. Cl. 264/165

(57) ABSTRACT

The present invention provides a process for producing a liquid crystal polyester-impregnated base material, comprising steps of (1) impregnating a fiber sheet with a liquid composition containing a liquid crystal polyester and an organic solvent dissolving the liquid crystal polyester, (2) removing the organic solvent from the impregnated liquid composition, thereby forming an intermediate, and (3) heat treating the intermediate at 270° C. or higher and a lower temperature than a pyrolysis temperature of the liquid crystal polyester.

### FIELD OF THE INVENTION

The present invention relates to a process for producing a liquid crystal polyester-impregnated base material.

### BACKGROUND OF THE INVENTION

There has been used a prepreg as a formation material of a printed-wiring board used for various electronic devices, the prepreg being produced by a process comprising steps of (i) impregnating a fiber sheet with a varnish obtained by dissolving a resin in an organic solvent, and (ii) removing the organic solvent from the impregnated varnish, thereby curing the resin contained in the fiber sheet. While the above resin is preferably an epoxy resin (for example, JP11-12464A), the epoxy resin is often used in combination with a flame retardant such as a bromine-modified resin and a bromine-containing flame retardant.

### SUMMARY OF THE INVENTION

However, use of such a bromine-containing compound for fire retardancy is not preferable in European Union (EU) because of RoHS (Restriction of Hazardous Substances) regulating use of harmful materials for parts of electric products.

An object of the present invention is to provide a process for producing a liquid crystal polyester-impregnated base material having excellent fire retardancy without the use of a flame retardant such as a bromine-modified resin and a bromine-containing flame retardant.

The present invention is a process for producing a liquid crystal polyester-impregnated base material, comprising steps of:

(1) impregnating a fiber sheet with a liquid composition containing a liquid crystal polyester and an organic solvent dissolving the liquid crystal polyester:

(2) removing the organic solvent from the impregnated liquid composition, thereby forming an intermediate; and

(3) heat treating the intermediate at 270° C. or higher and a lower temperature than a pyrolysis temperature of the liquid crystal polyester.

### DETAILED DESCRIPTION OF THE INVENTION

A liquid crystal polyester used in the present invention shows liquid crystallinity in its molten state, and has a melting temperature of preferably 450° C. or lower. The liquid crystal polyester may be a liquid crystal polyester amide, a liquid crystal polyester ether, a liquid crystal polyester carbonate, or a liquid crystal polyester imide. The liquid crystal polyester is preferably a wholly aromatic liquid crystal polyester which is obtained using only an aromatic compound as a starting monomer.

Typical examples of the liquid crystal polyester are a liquid crystal polyester obtained by a polymerization reaction (polycondensation reaction) of an aromatic hydroxycarboxylic acid with an aromatic dicarboxylic acid and one or more kinds of compounds selected from the group consisting of an aromatic diol, an aromatic hydroxyamine and an aromatic diamine; a liquid crystal polyester obtained by a polymerization reaction of plural kinds of aromatic hydroxycarboxylic acids; a liquid crystal polyester obtained by a polymerization reaction of an aromatic dicarboxylic acid with one or more kinds of compounds selected from the group consisting of an aromatic diol, an aromatic hydroxyamine and an aromatic diamine; and a liquid crystal polyester obtained by a polymerization reaction of a polyester such as polyethylene terephthalate with an aromatic hydroxycarboxylic acid. A part or all of the above aromatic hydroxycarboxylic acid, aromatic dicarboxylic acid, aromatic diol, aromatic hydroxyamine or aromatic diamine may be replaced with its polymerizable derivatives.

Regarding the polymerizable derivatives, examples thereof of a compound having a carboxyl group, such as an aromatic hydroxycarboxylic acid and an aromatic dicarboxylic acid are its ester derivative in which the carboxyl group has been converted into an alkoxycarbonyl group or an aryloxycarbonyl group, its acid halide derivative in which the carboxyl group has been converted into a haloformyl group, and its acid anhydride derivative in which the carboxyl group has been converted into an acyloxycarbonyl group. Examples of the polymerizable derivatives of a compound having a hydroxyl group, such as an aromatic hydroxycarboxylic acid, an aromatic diol and an aromatic hydroxylamine are its acylate derivative in which the hydroxyl group has been converted into an acyloxyl group through acylation. Examples of the polymerizable derivative of a compound having an amino group, such as an aromatic hydroxyamine or an aromatic diamine are its acylate derivative in which the amino group has been converted into an acylamino group through acylation.

The liquid crystal polyester used in the present invention contains preferably a repeating unit represented by following formula (1) (referred to hereinafter as “repeating unit (1)”), and more preferably repeating unit (1), a repeating unit represented by following formula (2) (referred to hereinafter as “repeating unit (2)”) and a repeating unit represented by following formula (3) (referred to hereinafter as “repeating unit (3)”):

—O—Ar¹—CO—, (1)

—CO—Ar²—CO—, (2)

—X—Ar³—Y—, (3)

—Ar⁴—Z—Ar⁵— (4)

wherein Ar¹ represents a phenylene group, a naphthylene group or a biphenylylene group; Ar² and Ar³ represent independently of each other a phenylene group, a naphthylene group, a biphenylylene group or a group represented by above formula (4); X and Y represent independently of each other an oxygen atom or an imino group (—NH—); Ar⁴ and Ar⁵ represent independently of each other a phenylene group or a naphthylene group; Z represents an oxygen atom, a sulfur atom, a carbonyl group or a sulfonyl group; and one or more hydrogen atoms contained in the group represented by Ar¹, Ar² or Ar³ may be substituted independently of one another with a halogen atom, an alkyl group or an aryl group.

Examples of the above halogen atom are a fluorine atom, a chlorine atom, a bromine atom and an iodine atom. Examples of the above alkyl group are an alkyl group having preferably 1 to 10 carbon atoms, such as a methyl group, an ethyl group, a n-propyl group, an isopropyl group, a n-butyl group, an isobutyl group, a sec-butyl group, a tert-butyl group, a n-hexyl group, a 2-ethylhexyl group, a n-octyl group and a n-decyl group. Examples of the above aryl group are an aryl group having preferably 6 to 20 carbon atoms, such as a phenyl group, an o-tolyl group, a m-tolyl group, a p-tolyl group, a 1-naphthyl group and a 2-naphthyl group. When the above one or more hydrogen atoms are substituted with a halogen atom, an alkyl group or an aryl group, the number of a substituent contained in Ar¹, Ar² or Ar³ is preferably 2 or less, and more preferably 1 or less, independently of one another.

Repeating unit (1) is derived from the above-mentioned aromatic hydroxycarboxylic acid. Repeating unit (1) is preferably a repeating unit derived from p-hydroxybenzoic acid in which Ar¹ is a p-phenylene group, or a repeating unit derived from 6-hydroxy-2-naphthoic acid in which Ar¹ is 2,6-naphthylene group.

Repeating unit (2) is derived from the above-mentioned aromatic dicarboxylic acid. Repeating unit (2) is preferably a repeating unit derived from terephthalic acid in which Ar² is a p-phenylene group, a repeating unit derived from isophthalic acid in which Ar² is a m-phenylene group, a repeating unit derived from 2,6-naphthalenedicarboxylic acid in which Ar² is a 2,6-naphthylene group, or a repeating unit derived from diphenyl ether-4,4′-dicarboxylic acid in which Ar² is a diphenyl ether-4,4′-dilyl group.

Repeating unit (3) is derived from the above-mentioned aromatic diol, aromatic hydroxylamine or aromatic diamine.

Repeating unit (3) is preferably a repeating unit derived from hydroquinone, p-aminophenol or p-phenylenediamine in which Ar³ is a p-phenylene group, or a repeating unit derived from 4,4′-dihydroxybiphenyl, 4-amino-4′-hydroxybiphenyl or 4,4′-diaminobiphenyl in which Ar³ is a 4,4′-biphenylylene group.

Respective amounts of repeating units (1), (2) and (3) contained in the liquid crystal polyester are explained below. Providing the total amount of repeating units (1), (2) and (3) contained in the liquid crystal polyester is 100 units, an amount of repeating unit (1) contained in the liquid crystal polyester is preferably 30 units or more, more preferably 30 to 80 units, further preferably 30 to 60 units, and even further preferably 30 to 40 units; an amount of repeating unit (2) contained in the liquid crystal polyester is preferably 35 units or less, more preferably 10 to 35 units, further preferably 20 to 35 units, and even further preferably 30 to 35 units; and an amount of repeating unit (3) contained in the liquid crystal polyester is preferably 35 units or less, more preferably 10 to 35 units, further preferably 20 to 35 units, and even further preferably 30 to 35 units. As the amount of repeating unit (1) is increased, the liquid crystal polyester is apt to be improved in its heat resistance, strength and rigidity. However, when the amount of repeating unit (1) is larger than 80 units, the liquid crystal polyester is apt to be low in its solubility in a solvent.

A ratio of the amount of repeating unit (2) contained in the liquid crystal polyester to the amount of repeating unit (3) contained therein is preferably 0.9/1 to 1/0.9, more preferably 0.95/1 to 1/0.95, and further preferably 0.98/1 to 1/0.98.

The liquid crystal polyester may contain two or more kinds of respective repeating units (1) to (3). Also, the liquid crystal polyester may contain other repeating unit than repeating units (1) to (3), in an amount of usually 10 units or less, and preferably 5 units or less, provided that the total of all repeating units contained in the liquid crystal polyester is 100 units.

In order to obtain the liquid crystal polyester having excellent solubility in a solvent, it is preferable that the liquid crystal polyester contains repeating unit (3) whose X and/or Y are an imino group, and it is more preferable that all of repeating unit (3) in the liquid crystal polyester contains an imino group as X and/or Y, wherein repeating unit (3) containing an imino group as X and/or Y is derived from an aromatic hydroxylamine or an aromatic diamine.

The liquid crystal polyester is preferably produced by a method with satisfactory operability, comprising steps of (i) melt-polymerizing starting monomers providing respective repeating units (1) to (3), thereby producing a polymer (referred to hereinafter as “prepolymer”); and (ii) solid phase-polymerizing the prepolymer, thereby obtaining a high molecular weight liquid crystal polyester having a thermal resistance and high strength and rigidity. Step (i) may be carried out in the presence of a catalyst, and examples thereof are a metal compound such as magnesium acetate, stannous acetate, tetrabutyl titanate, lead acetate, sodium acetate, potassium acetate and antimony trioxide; and a nitrogen-containing heterocyclic compound such as 4-(dimethylamino)pyridine and 1-methylimidazole. Among them, preferred is a nitrogen-containing heterocyclic compound.

The liquid crystal polyester has a flow beginning temperature of preferably 250° C. or higher, more preferably 250 to 350° C., and further preferably 260 to 330° C. When the flow beginning temperature is higher, the liquid crystal polyester is apt to be improved in its heat resistance, strength and rigidity. However, when the flow beginning temperature is higher than 350° C., the liquid crystal polyester is apt to be low in its solubility in a solvent, and the above-mentioned liquid composition is apt to be high in its viscosity. The flow beginning temperature is also called a flow temperature, and is an indication of a molecular weight—of the liquid crystal polyester (see “Liquid Crystal Polymer—Synthesis, Molding and Application—” edited by Naoyuki Koide, page 95, published by CMC CO., LTD., issued on Jun. 5, 1987). The flow beginning temperature is the temperature at which the liquid crystal polyester indicates melt viscosity of 4,800 Pa·s (48,000 poise), and is measured using a capillary rheometer by a method comprising steps of (1) heating the liquid crystal polyester at a temperature-increasing rate of 4° C./minute under a load of 9.8 MPa (100 kg/cm²), (2) extruding the melted liquid crystal polyester through a nozzle having an inner diameter of 1 mm and length of 10 mm, and (3) observing a temperature at which the melted liquid crystal polyester indicates a melt viscosity of 4,800 Pa·s (48,000 poise).

The above-mentioned organic solvent used in the present invention is an organic solvent capable of dissolving the liquid crystal polyester, and is specifically an organic solvent capable of making a solution having a concentration of 1% by weight or higher at 50° C., provided that the total of the liquid crystal polyester and the organic solvent is 100% by weight.

Examples of the organic solvent are a halogenated hydrocarbon such as dichloromethane, chloroform, 1,2-dichloroethane, 1,1,2,2-tetrachloroethane and o-dichlorobenzene; a halogenated phenol such as p-chlorophenol, pentachlorophenol and pentafluorophenol; an ether such as diethyl ether, tetrahydrofuran and 1,4-dioxane; a ketone such as acetone and cyclohexanone; an ester such as ethyl acetate and γ-butyrolactone; a carbonate such as ethylene carbonate and propylene carbonate; an amine such as triethylamine; a nitrogen-containing heterocyclic aromatic compound such as pyridine; a nitrile such as acetonitrile and succinonitrile; an amide bond-containing amide organic solvent such as N,N-dimethylformamide, N,N-dimethylacetamide and N-methylpyrrolidone; a urea compound such as tetramethylurea; a nitro compound such as nitromethane and nitrobenzene; a sulfur compound such as dimethylsulfoxide and sulfolane; a phosphorous compound such as hexamethylphosphoramide and tri-n-butylphosphoric acid; and a combination of two or more of those solvents.

From a viewpoint of low corrosiveness and easy handling, the organic solvent is preferably a solvent containing an aprotic compound, especially an aprotic compound containing no halogen atom, as a major component. The aprotic compound is used in an amount of preferably 50 to 100% by weight, more preferably 70 to 100% by weight, and further preferably 90 to 100% by weight, provided that the total of a solvent used is 100% by weight. The aprotic compound is preferably an amide compound such as N,N-dimethylformamide, N,N-dimethylacetamide and N-methylpyrrolidone, and more preferably an amide compound containing no halogen atom, from a viewpoint of good solubility of the liquid crystal polyester.

From a viewpoint of good solubility of the liquid crystal polyester, the organic solvent is preferably a solvent containing as a major component a compound having a dipole moment of 3 to 5. The compound having a dipole moment of 3 to 5 is used in an amount of preferably 50 to 100% by weight, more preferably 70 to 100% by weight, and further preferably 90 to 100% by weight, provided that the total of a solvent used is 100% by weight. Therefore, the above aprotic compound in the present invention is particularly preferably a compound having a dipole moment of 3 to 5.

In order to remove easily the organic solvent in step (2), preferred is the organic solvent which contains as a major component a compound having boiling temperature of 220° C. or lower under one atmospheric pressure. The compound having boiling temperature of 220° C. or lower under one atmospheric pressure is used in an amount of preferably 50 to 100% by weight, more preferably 70 to 100% by weight, and further preferably 90 to 100% by weight, provided that the total of a solvent used is 100% by weight. Therefore, it is preferable to use as the above aprotic compound a compound having boiling temperature of 220° C. or lower under one atmospheric pressure.

The above liquid composition used in step (1) contains the liquid crystal polyester in amount of preferably 5 to 60% by weight, more preferably 10 to 50% by weight, and further preferably 15 to 45% by weight, in order to obtain the liquid composition having intended viscosity, provided that the total of the liquid crystal polyester and the organic solvent is 100% by weight.

The liquid composition may contain one or more components such as a filler, an additive and a resin other than the liquid crystal polyester. Examples of the filler are an inorganic filler such as silica, alumina, titanium oxide, barium titanate, strontium titanate, aluminum hydroxide and calcium carbonate; and an organic filler such as a cured epoxy resin, a cross-linked benzoguanamine resin and a cross-linked acrylic resin. The filler may be contained in the liquid composition in an amount of preferably 0 to 100 parts by weight, per 100 parts by weight of the liquid crystal polyester. Examples of the additive are a leveling agent, an antifoaming agent, an antioxidant, an ultraviolet absorber, a flame retardant and a coloring agent. The additive may be contained in the liquid composition in an amount of preferably 5 parts by weight or less, per 100 parts by weight of the liquid crystal polyester. Examples of the resin other than the liquid crystal polyester are a thermoplastic resin such as polypropylene, a polyamide, a polyester other than the above-mentioned liquid crystal polyester, a polyphenylene sulfide, a polyether ketone, a polycarbonate, a polyethersulfone, a polyphenylene ether and a polyetherimide; and a thermosetting resin such as a phenol resin, an epoxy resin, a polyimide resin and a cyanate resin. The resin other than the liquid crystal polyester may be contained in the liquid composition in an amount of preferably 20 parts by weight or less, per 100 parts by weight of the liquid crystal polyester.

The liquid composition can be prepared by mixing the liquid crystal polyester with the organic solvent and optional components in a lump sum or in a suitable mixing sequence. When the filler is used the liquid composition is prepared preferably by a method comprising steps of (1) dissolving the liquid crystal polyester in the organic solvent to obtain a solution, and (2) dispersing the filler in the solution.

Examples of a fiber forming the fiber sheet used in step (1) are an inorganic fiber such as a glass fiber (for example, an alkali glass fiber, an alkali-free glass fiber and a low-dielectric glass fiber), a carbon fiber and a ceramic fiber; an organic fiber such as an aromatic polyamide fiber, a polyimide fiber, poly-p-phenylenebenzobisoxazole fiber (PBO fiber) and a liquid crystal polymer fiber; and a combination of two or more thereof. Among them, preferred is a glass cloth which is a glass fiber-containing sheet. The organic fiber is preferably a heat-resistant fiber which does not melt at a heat-treating temperature in step (3).

The fiber sheet is not particularly limited in its figure. Examples of the figure are a textile, a knit and an unwoven fabric. Among them, preferred is a textile from a viewpoint of improved dimension stability of an impregnated sheet obtained in step (1). Examples of the weave of a woven fabric are a plain weave, a sateen weave, a twill weave and a basket weave. The weave density of the woven fabric is generally 10 to 100/25 mm.

The fiber sheet has a thickness of preferably 10 to 200 μm and more preferably 10 to 180 μm, and has a weight per unit area of preferably 10 to 300 g/m². In order to improve adhesiveness between the fiber sheet and the liquid crystal polyester contained in the liquid composition, a surface of the fiber sheet may be treated in advance with a coupling agent such as a silane coupling agent, an aminosilane coupling agent, an epoxysilane coupling agent and a titanate coupling agent.

Examples of a production method of the fiber sheet are (1) a method comprising steps of (1-1) dispersing a fiber in water (if desired, a resin such as an acrylic resin is added to the water), (1-2) subjecting the resultant dispersion liquid to a paper machine, and (1-3) drying the resultant paper-like material, thereby obtaining an unwoven fabric, and (2) a method comprising a step of weaving a fiber with a weaving machine known in the art.

An example of the fiber sheet easily available in the market is a glass cloth. Various glass cloths are commercially available as an insulated and impregnated base material of an electronic part, and are available from a manufacturer such as Asahi Kasei E-materials Corp., Nitto Boseki Co., Ltd. and Arisawa Manufacturing Co., Ltd. Among glass cloths available in the market, examples of the glass cloth having a preferable thickness are glass cloths having respective IPC designations of 1035, 1078, 2116 and 7628.

An example of a typical method of impregnating the fiber sheet with the liquid composition is a method comprising a step of dipping the fiber sheet in a dipping vessel holding the liquid composition. This method can regulate an amount of the liquid crystal polyester adhered to the fiber sheet by controlling a factor such as (1) a content of the liquid crystal polyester contained in the liquid composition, (2) a dipping condition of the fiber sheet in the dipping vessel, and (3) a removing condition of an extra liquid composition adhered to the fiber sheet. Examples of the condition in factor (2) are (2-1) a dipping time and (2-2) a lifting speed of the fiber sheet impregnated with the liquid composition from the dipping vessel. An example of the condition in factor (3) is a distance between two rolls, wherein the fiber sheet impregnated with the liquid composition is squeezed by passing through between those two rolls, thereby removing an extra liquid composition adhered to the fiber sheet.

The fiber sheet impregnated with the liquid composition in step (1) is subjected to step (2), in order to remove the organic solvent, thereby forming an intermediate which is the fiber sheet containing the liquid crystal polyester. A removing method of the organic solvent is not particularly limited. The removing method is preferably a method comprising a step of evaporating the organic solvent, from a viewpoint of an easy-to-use removing operation. This evaporating method is preferably combined with one or more selected from the group consisting of heating, depressurization and ventilation, in order to promote the evaporation of the organic solvent.

The heat treatment in step (3) promotes a polymerization reaction of the liquid crystal polyester contained in the intermediate, and therefore increases a molecular weight of the liquid crystal polyester, which improves heat resistance and strength of the obtained liquid crystal polyester-impregnated base material. The heat treatment in step (3) is carried out at 270° C. or higher and a lower temperature than a pyrolysis temperature of the liquid crystal polyester, preferably at 280° C. or higher and a lower temperature than a pyrolysis temperature of the liquid crystal polyester in order to obtain a liquid crystal polyester-impregnated base material having better heat resistance, and more preferably at 290 to 330° C., and for 1 to 30 hours, and preferably 3 to 10 hours from a viewpoint of productivity and heat resistance of a liquid crystal polyester-impregnated base material. When the temperature is lower than 270° C., the above-mentioned polymerization reaction is hardly promoted, which results in insufficient heat resistance of the obtained liquid crystal polyester-impregnated base material. When the temperature is a pyrolysis temperature of the liquid crystal polyester or higher, the liquid crystal polyester is thermally decomposed, which does not result in an intended liquid crystal polyester-impregnated base material. Step (3) is carried out preferably at 290° C. or higher and a lower temperature than a pyrolysis temperature of the liquid crystal polyester for 3 hours or longer.

Step (3) is carried out in an atmosphere of an oxygen concentration of preferably lower than 500 ppm (0.05% by volume), in order to inhibit oxidation of the liquid crystal polyester contained in the above-mentioned intermediate, which prevents deterioration of properties of the obtained liquid crystal polyester-impregnated base material. The above oxygen concentration at the beginning of step (3) is lower than the above concentration, preferably lower than 100 ppm (0.01% by volume), and more preferably lower than 50 ppm (0.005% by volume).

The above-mentioned atmosphere in step (3) is adjusted, for example, by a method of purging an inside of a heat-treating apparatus such as a furnace with an inert gas such as nitrogen, helium and argon. Examples of a method of purging an inside of a furnace with nitrogen gas are (1) a method comprising a step of introducing nitrogen gas into the furnace, thereby pushing out air existing in the inside of the furnace; and (2) a method comprising steps of (2-1) deairing the inside of the furnace, and (2-2) introducing nitrogen gas into the furnace, those steps being repeated. The methods (1) and (2) may be carried out while operating the furnace, for example, while raising temperature in the furnace up to 100° C. After measuring an oxygen concentration inside the furnace to make sure that the oxygen concentration reaches the desired value or less, the furnace is heated up to a heat-treating temperature, and step (3) is carried out.

It is possible to produce a liquid crystal polyester-impregnated base material having a conductive layer, by a method comprising steps of (1) laminating two or more liquid crystal polyester-impregnated base materials obtained by the process of the present invention, by a laminating method such as a hot press method, and (2) forming a conductive layer such as a metal thin film on at least one surface of the resultant laminate.

Examples of a method for forming a conductive layer in above step (2) are (2-1) a method comprising a step of bonding a metal foil with an adhesive, (2-2) a method comprising a step of thermal-fusion bonding with a hot press, and (2-3) a method comprising a step of coating with a metal particle by a method such as a plating method, a screen-printing method and a sputtering method. Examples of a metal of the above metal foil or metal particle are cupper, aluminum and silver. Among them, preferred is cupper from a viewpoint of conductive property and cost.

The lamination of two or more liquid crystal polyester-impregnated base materials in above step (1) is preferable in case that a use of only one liquid crystal polyester-impregnated base material is insufficient in its stiffness. Examples of a method for producing the above-mentioned liquid crystal polyester-impregnated base material having a conductive layer, which comprises two or more liquid crystal polyester-impregnated base materials and a conductive layer, are (1) a method comprising a step of laminating a liquid crystal polyester-impregnated base material having a conductive layer with a liquid crystal polyester-impregnated base material having no conductive layer, and (2) a method comprising a step of forming a conductive layer on a laminated product of two or more liquid crystal polyester-impregnated base materials.

The hot press in above method (2-2) is carried out at preferably 300 to 360° C., and more preferably 320 to 340° C., under a pressure of preferably 1 to 20 MPa, and more preferably 3 to 10 MPa, for preferably 5 to 60 minutes, and more preferably 10 to 50 minutes. The hot press is carried out preferably in a reduced-pressure atmosphere of 5 kPa or lower.

Since the above liquid crystal polyester-impregnated base material having a conductive layer contains a liquid crystal polyester-containing base material having good heat resistance, the liquid crystal polyester-impregnated base material having a conductive layer can be provided with an intended wiring pattern on its conductive layer, thereby producing a printed-wiring board which contains an insulating layer having excellent fire retardancy.

According to the present invention, there can be produced a liquid crystal polyester-impregnated base material having excellent fire retardancy without the use of a flame retardant such as a bromine-modified resin and a bromine-containing flame retardant.

### EXAMPLE

The present invention is explained in more detail with reference to the following Example, which does not limit the present invention.

### Reference Example 1

### Production of Liquid Crystal Polyester

A reactor equipped with a stirrer having a torquemeter, a nitrogen gas-inlet tube, a thermometer and a reflux condenser was provided with 1,976 g (10.5 mol) of 6-hydroxy-2-naphthoic acid, 1,474 g (9.75 mol) of 4-hydroxyacetanilide, 1,620 g (9.75 mol) of isophthalic acid and 2,374 g (23.25 mol) of acetic anhydride. An empty space of the reactor was purged with nitrogen gas. The resultant mixture was stirred and heated in an atmosphere of nitrogen gas stream from room temperature up to 150° C. over 15 minutes, and was refluxed at 150° C. for 3 hours.

Next, the mixture was heated from 150° C. up to 300° C. over 2 hours and 50 minutes while distilling away by-product acetic acid formed during the above reflux and unreacted acetic anhydride. The reaction mixture was taken out of the reactor, and was cooled to room temperature. The obtained solid material was crushed with a crusher, thereby obtaining a prepolymer. The prepolymer was found to have a flow beginning temperature of 235° C.

The prepolymer was crushed, and the resultant powdery prepolymer was bedded in a metal tray. The metal tray was put in a hot-air dryer, IPHH-201M, manufactured by ESPEC Corp., and was heated from room temperature up to 223° C. over 6 hours, and was further heated at 223° C. for 3 hours, thereby solid phase-polymerizing the powdery prepolymer. The obtained powdery material was cooled, thereby obtaining a powdery liquid crystal polyester. The liquid crystal polyester was found to have a flow beginning temperature of 270° C.

The above flow beginning temperature was measured using a flow tester, CFT-500, manufactured by Shimadzu Corporation, by a method comprising steps of (i) putting about 2 g of a sample in a cylinder equipped with a die having a nozzle (inner diameter of 1 mm and length of 10 mm), (ii) melting the sample by heating at a temperature-increasing rate of 4° C./minute under a load of 9.8 MPa (100 kg/cm²), (iii) extruding the melted sample through the nozzle, and (iv) observing a temperature (flow beginning temperature) at which the melted sample indicates a melt viscosity of 4,800 Pass (48,000 poise).

### Example 1

### (1) Production of Liquid Composition A

There was dried 22 parts by weight of the above liquid crystal polyester in a circulation dryer at 120° C. for 2 hours. The dried liquid crystal polyester was added to 78 parts by weight of N,N-dimethylacetamide. The resultant mixture was heated at 100° C. for 2 hours in a nitrogen atmosphere, and then was cooled, thereby obtaining liquid composition A.

### (2) Production of Liquid Crystal Polyester-Impregnated Base Material

A 96 μm-thick glass cloth having an IPC designation of 2116, manufactured by Arisawa Manufacturing Co., Ltd., was impregnated with above liquid composition A. The solvent (N,N-dimethylacetamide) contained in the impregnated glass cloth was evaporated at 160° C. using a hot-air dryer, thereby obtaining an intermediate containing the liquid crystal polyester.

The intermediate was placed in a hot-air dryer, IPHH-201M, manufactured by ESPEC Corp. The hot-air dryer was purged with a nitrogen gas, and the intermediate was heated in a nitrogen atmosphere at 320° C. for 10 hours, thereby obtaining a liquid Crystal polyester-impregnated base material. The liquid crystal polyester-impregnated base material was found to have fire retardancy of V-0 (UL94 flame test). Results are summarized in Table 1.

The above fire retardancy was measured by the following method, in reference to a vertical flame test prescribed in UL94 standards “Tests for Flammability of Plastic Materials for Parts in Devices and Appliances”, comprising steps of:

(1) punching out the liquid crystal polyester-impregnated base material, thereby preparing a strip specimen having a size of 127 mm (length)×12.7 mm (width)×0.2 mm (thickness);

(2) conditioning the strip specimen for 48 hours under conditions of 23±2° C. (temperature) and 50±5% RH (humidity);

(3) holding the strip specimen under conditions of 20° C. (temperature) and 65% RH (humidity) in a manner such that its long side has a vertical direction;

(4) contacting a gas burner flame at the lower end of the strip specimen for 10 seconds;

(5) in case that the combustion of the strip specimen stops within 30 seconds, further contacting the gas burner flame at the lower end thereof for 10 seconds; and

(6) applying above steps (2) to (5) to five strip specimens in total, respectively.

### Example 2

Example 1 was repeated except that the heat treatment of the intermediate at 320° C. for 10 hours was changed to the heat treatment thereof at 290° C. for 3 hours, thereby obtaining a liquid crystal polyester-impregnated base material having fire retardancy of V-0. Results are summarized in Table 1.

### Example 3

### (1) Production of Liquid Composition B

There were mixed with one another 100 parts by weight of above liquid composition A, 9 parts by weight of a silica filler, CA-0020, manufactured by Korea Semiconductor Material Co., Ltd., and 11 parts by weight of a glass bead, EGB503MM, as a dispersion medium manufactured by Potters-Balotini Co., Ltd. The resultant mixture was agitated using a stirred defoaming devise, AR-500, manufactured by Thinky Inc. at an agitation rate of 1,000 rpm for 10 minutes, and further at an agitation rate of 1,500 rpm for 5 minutes. The defoamed mixture was filtrated to remove the dispersion medium, thereby obtaining liquid composition B.

### (2) Production of Liquid Crystal Polyester-Impregnated Base Material

Example 1 was repeated except that (i) liquid composition A was changed to above liquid composition B, an (ii) the heat treatment of the intermediate at 320° C. for 10 hours was changed to the heat treatment thereof at 290° C. for 3 hours, thereby obtaining a liquid crystal polyester-impregnated base material having fire retardancy of V-0. Results are summarized in Table 1.

### Comparative Example 1

Example 1 was repeated except that the heat treatment of the intermediate at 320° C. for 10 hours was changed to the heat treatment thereof at 260° C. for 3 hours, thereby obtaining a liquid crystal polyester-impregnated base material. Its fire retardancy was found to be below the standard of UL-94. Results are summarized in Table 1.

TABLE 1

| | Example | | | Comparative |
|---|---|---|---|---|
| | 1 | 2 | 3 | Example 1 |
| Liquid composition | A | A | B | A |
| Heat treatment in step (3) | | | | |
| Temperature (° C.) | 320 | 290 | 290 | 260 |
| Time (hour) | 10 | 3 | 3 | 3 |
| Fire retardancy | | | | |
| (UL94 flame test ) | V-0 | V-0 | V-0 | below standard |

Table 1 shows clearly that the fire retardancy in Examples 1 to 3 was all V-0, and the fire retardancy in Comparative Example 1 (heat-treatment at 260° C.) was below the standard of UL-94.

1. A process for producing a liquid crystal polyester-impregnated base material, comprising steps of:
(1) impregnating a fiber sheet with a liquid composition containing a liquid crystal polyester and an organic solvent dissolving the liquid crystal polyester:
(2) removing the organic solvent from the impregnated liquid composition, thereby forming an intermediate; and
(3) heat treating the intermediate at 270° C. or higher and a lower temperature than a pyrolysis temperature of the liquid crystal polyester.

2. The process according to claim 1, wherein the fiber sheet is a glass cloth.

3. The process according to claim 1, wherein the liquid crystal polyester contains a repeating unit represented by following formula (1), a repeating unit represented by following formula (2) and a repeating unit represented by following formula (3):
—O—Ar¹—CO—, (1)
—CO—Ar²—CO—, (2)
—X—Ar³—Y—, (3)
—Ar⁴—Z—Ar⁵— (4)
wherein Ar¹ represents a phenylene group, a naphthylene group or a biphenylylene group; Ar² and Ar³ represent independently of each other a phenylene group, a naphthylene group, a biphenylylene group or a group represented by above formula (4); X and Y represent independently of each other an oxygen atom or an imino group (—NH—); Ar⁴ and Ar⁵ represent independently of each other a phenylene group or a naphthylene group; Z represents an oxygen atom, a sulfur atom, a carbonyl group or a sulfonyl group; and one or more hydrogen atoms contained in the group represented by Ar¹, Ar² or Ar³ may be substituted independently of one another with a halogen atom, an alkyl group or an aryl group.

4. The process according to claim 3, wherein the liquid crystal polyester contains the repeating unit represented by formula (1) in an amount of 30 to 80 units, the repeating unit represented by formula (2) in an amount of 10 to 35 units, and the repeating unit represented by formula (3) in an amount of 10 to 35 units, provided that the total amount of repeating units represented by respective formulas (1), (2) and (3) contained in the liquid crystal polyester is 100 units.

5. The process according to claim 3, wherein X and/or Y are an imino group.

6. The process according to claim 1, wherein step (3) is carried out at 290° C. or higher and a lower temperature than a pyrolysis temperature of the liquid crystal polyester for 3 hours or longer.
